(19) United States
(12) Patent Application Publication
(10) Pub. No.: US 2013/0157863 A1
(43) Pub. Date: Jun. 20, 2013

(54) MICROCAPSULE DISPERSION COMPRISING MICROCAPSULES WITH A HYDROPHILIC CAPSULE CORE

(71) Applicants: Peter HAHN, Obrigheim (DE); Markus Brym, Limburgerhof (DE); Harald Keller, Ludwigshafen (DE); Christian Nitschke, Speyer (DE); Hans Willax, Maxdorf (DE); Britta Katz, Dannstadt-Schauernheim (DE); Jutta Brust, Kallstadt (DE); Tina Schroeder-Grimonpont, Rheinzabern (DE); Ralph Rieger, Ludwigshafen (DE); Regina Klein, Speyer (DE)

(72) Inventors: Peter HAHN, Obrigheim (DE); Markus Brym, Limburgerhof (DE); Harald Keller, Ludwigshafen (DE); Christian Nitschke, Speyer (DE); Hans Willax, Maxdorf (DE); Britta Katz, Dannstadt-Schauernheim (DE); Jutta Brust, Kallstadt (DE); Tina Schroeder-Grimonpont, Rheinzabern (DE); Ralph Rieger, Ludwigshafen (DE); Regina Klein, Speyer (DE)

(21) Appl. No.: 13/716,827

(22) Filed: Dec. 17, 2012

Related U.S. Application Data
(60) Provisional application No. 61/577,105, filed on Dec. 19, 2011.

(51) Int. Cl. C08L 39/00; C08L 33/14; C08L 33/26

(52) U.S. Cl. CPC C08L 39/00; C08L 33/26; C08L 33/14
USPC 504/359; 524/555; 524/558; 524/548; 424/451

(57) ABSTRACT

The present invention relates to microcapsule dispersions comprising microcapsules comprising a hydrophilic capsule core and a capsule wall polymer which is obtainable by polymerization of a monomer composition comprising
25 to 95% by weight of one or more C₁-C₂₄-alkyl and/or glycidyl esters of acrylic acid and/or methacrylic acid
5 to 75% by weight of one or more hydrophilic monomers selected from acrylic acid esters and/or methacrylic acid esters which carry hydroxy and/or carboxy groups, and allylgluconamide
0 to 40% by weight of one or more compounds having two or more ethylenically unsaturated radicals,
   where the microcapsules are dispersed in a hydrophobic diluents, to the microcapsules, and to a method for producing them and to their use for the delayed release of active ingredients for construction, cosmetics or crop protection applications.

The present invention relates to microcapsule dispersions comprising microcapsules comprising a hydrophilic capsule core and a capsule wall polymer which is obtainable by polymerization of a monomer composition comprising
25 to 95% by weight of one or more C₁-C₂₄-alkyl and/or glycidyl esters of acrylic acid and/or methacrylic acid
5 to 75% by weight of one or more hydrophilic monomers selected from acrylic acid esters and/or methacrylic acid esters which carry hydroxy and/or carboxy groups, and allylgluconamide
0 to 40% by weight of one or more compounds having two or more ethylenically unsaturated radicals,
   where the microcapsules are dispersed in a hydrophobic diluents, to the microcapsules, and to a method for producing them and to their use for the delayed release of active ingredients for construction, cosmetics or crop protection applications.

Microcapsules with a hydrophobic capsule core are known for numerous applications. EP 457 154 teaches microcapsules with a core oil comprising color formers and walls which are obtained by polymerization of methacrylates in an oil-in-water emulsion. EP 1029018 describes microcapsules with capsule wall polymers based on (meth)acrylates and a capsule core of lipophilic waxes as latent heat storage materials.

Furthermore, WO 2011/064312 teaches microcapsules with crop protection active ingredients dissolved in a hydrophobic oil as capsule core and likewise a capsule wall based on (meth)acrylate.

In contrast to the oil-in-water emulsions in which the oil is the disperse phase, i.e. the discontinuous phase, and the water is the continuous phase, encapsulation methods are also known in which the two phases are swapped. These methods are also referred to as inverse microencapsulation.

DE 10120480 describes such an inverse encapsulation. It teaches microcapsules with a capsule core comprising water-soluble substances and a capsule wall of melamine/formaldehyde resins. Furthermore, WO 03/015910 teaches microcapsules with a capsule core comprising water-soluble substances and a capsule wall of polyureas.

EP-A-0 148 169 describes microcapsules with a water-soluble core and a polyurethane wall which are produced in a vegetable oil. As capsule core material, as well as herbicides, water-soluble dyes, inter alia, are mentioned.

However, there thus continues to be a need for microcapsules with a capsule core comprising water which can be used, for example, as pore formers in construction materials. It is also desirable to protect in this way acid, the release of which can be controlled as accelerator for, for example, chipboard. Delayed release of water-soluble active ingredients for crop protection or cosmetic applications is also of interest.

It was an object of the present invention to encapsulate aqueous solutions or water itself.

Accordingly, the microcapsules described above and/or their dispersions in a hydrophobic diluent, and a method for producing them have been found.

The microcapsules according to the invention comprise a capsule core and a capsule wall. The capsule core consists predominantly, to more than 95% by weight, of water or aqueous solutions. The average particle size of the capsules (Z average by means of light scattering) is 0.5 to 50 μm. According to one preferred embodiment, the average particle size of the capsules is 0.5 to 15 μm, preferably 0.5 to 10 μm. In this connection, preferably 90% of the particles have a particle size of less than twice the average particle size.

The weight ratio of capsule core to capsule wall is in general from 50:50 to 95:5. Preference is given to a core/wall ratio of 70:30 to 93:7.

A hydrophilic capsule core (capsule core material) is to be understood as meaning water, and aqueous solutions of water-soluble compounds whose content is at least 10% by weight of a water-soluble compound. Preferably, the aqueous solutions are at least 20% by weight strength.

The water-soluble compounds are, for example, organic acids or salts thereof, inorganic acids, inorganic bases, salts of inorganic acids such as sodium chloride or sodium nitrate, water-soluble dyes, agrochemicals such as Dicamba®, flavorings, pharmaceutical active ingredients, fertilizers or cosmetic active ingredients. Preferred hydrophilic capsule core materials are water, and aqueous solutions of organic acids such as acetic acid, formic acid, propionic acid and methanesulfonic acid, and/or salts thereof, inorganic acids such as phosphoric acid and hydrochloric acid, and salts of inorganic acids, and sodium silicate.

Depending on the thickness of the capsule wall, which is influenced by the chosen process conditions and also amount of feed materials, the capsules are impermeable or sparingly permeable for the hydrophilic capsule core material. With sparingly permeable capsules, a controlled release of the hydrophilic capsule core material can be achieved. The water forming the capsule core will often evaporate from isolated microcapsules, i.e. microcapsules freed from the hydrophobic diluent, over the course of time.

Where -(meth)acrylates is used within the context of this application, both the corresponding -acrylates, i.e. the derivatives of acrylic acid, and also the -methacrylates, the derivatives of methacrylic acid, are intended.

The polymers of the capsule wall comprise generally at least 25% by weight, in preferred form at least 30% by weight and in particularly preferred form at least 40% by weight, and also in general at most 95% by weight, preferably at most 90% by weight and in particularly preferred form at most 80% by weight, of C₁-C₂₄-alkyl and/or glycidyl esters of acrylic acid and/or methacrylic acid (monomers I) in copolymerized form, based on the total weight of the monomers.

According to the invention, the polymers of the capsule wall generally comprise at least 5% by weight, preferably at least 10% by weight, preferably at least 15% by weight, and in general at most 75% by weight, preferably at most 60% by weight and, in a particularly preferred form, at most 55% by weight, of one or more hydrophilic monomers (II) selected from acrylic acid esters which carry hydroxy and/or carboxy groups, methacrylic acid esters which carry hydroxy and/or carboxy groups, and allylgluconamide, based on the total weight of the monomers, in copolymerized form.

In addition, the polymers can preferably comprise at least 5% by weight, preferably at least 10% by weight, preferably at least 15% by weight, and in general at most 40% by weight, preferably at most 35% by weight and, in a particularly preferred form, at most 30% by weight or one or more compounds having two or more ethylenically unsaturated radicals (monomers III) in copolymerized form, based on the total weight of the monomers.

Furthermore, up to 5% by weight of other monomers IV, which are different from the monomers I, II and III, may be present in the capsule wall in copolymerized form.

Preferably, the monomer composition consists of the monomers I and II, and optionally the monomers III, and optionally the monomers IV.

Suitable monomers I are C₁-C₂₄-alkyl esters of acrylic and/or methacrylic acid, and also the glycidyl esters of acrylic acid and/or methacrylic acid. Preferred monomers I are methyl, ethyl, n-propyl and n-butyl acrylate, and the corresponding methacrylates. In general, the methacrylates are preferred. Particular preference is given to C₁-C₄-alkyl methacrylates. According to a further embodiment, glycidyl methacrylate is preferred.

According to a particularly preferred embodiment, monomer I is methyl methacrylate, optionally in a mixture with glycidyl methacrylate and/or one or more C₂-C₂₄-alkyl esters of acrylic acid and/or methacrylic acid. The monomer composition particularly preferably comprises 25-40% by weight of methyl methacrylate.

Monomers II are selected from acrylic acid esters which carry hydroxyl and/or carboxy groups, methacrylic acid esters which carry hydroxyl and/or carboxy groups, and allylgluconamide. They are preferably (meth) acrylic acid esters which carry at least one radical selected from carboxylic acid and hydroxyl radical. The preferred (meth) acrylic acid esters are hydrophilic, i.e. they have a solubility in water of >50 g/l at 20° C. and atmospheric pressure.

The monomers II used are preferably hydroxyalkyl acrylates and hydroxyalkyl methacrylates such as 2-hydroxyethyl acrylate and methacrylate, hexapropyl acrylate and methacrylate, hydroxybutyl acrylate and diethylene glycol monoacrylate.

Further preferred hydrophilic monomers II are acrylamidoalkylpolyhydroxyacid amides, methacrylamidoalkyl-polyhydroxy acid amides, N-acryl-glycosylamines and N-methacryl-glycosylamines.

The preparation of the acrylamidoalkyl-polyhydroxy acid amides and of the methacrylamidoalkyl-polyhydroxyacid amides is known and described for example in WO 2010/118951. Furthermore, the preparation of the N-acryl-glycosylamines and N-methacryl-glycosylamines is known and described for example in WO 2010/118951.

Thus, the preparation of N-acryl-glycosylamines and N-methacryl-glycosylamines takes place in two steps by reacting an aldehyde sugar with a primary aliphatic amine or ammonia to give the corresponding glycosylamine, and reacting the resulting N-glycosylamine with the acrylic anhydride or methacrylic anhydride to give the N-acryl-glycosylamine or N-methacryl-glycosylamine, respectively. According to the invention, the two process steps are carried out directly after one another, i.e. without interim isolation.

Hereinbelow, aldehyde sugars are to be understood as meaning reducing sugars which carry an aldehyde group in their open-chain form. The aldehyde sugars used according to the invention are open-chain or cyclic mono- and oligosaccharides from natural and synthetic sources with an aldehyde radical and/or semiacetal thereof. In particular, the aldehyde sugars selected from monosaccharides and oligosaccharides in optically pure form are preferred. They are also suitable as stereoisomer mixture.

Monosaccharides are selected from aldoses, in particular aldo-pentoses and preferably aldo-hexoses. Suitable monosaccharides are, for example, arabinose, ribose, xylose, mannose and galactose, in particular glucose. Since the monosaccharides are reacted in aqueous solution, they are present, on account of the mutarotation, both in ring-like semiacetal form and also, to a certain percentage, in open-chain aldehyde form.

Preferably, the aldehyde sugar is an oligosaccharide. Oligosaccharides are understood as meaning compounds having 2 to 20 repeat units. Preferred oligosaccharides are selected from di-, tri-, tetra-, penta-, and hexa-, hepta-, octa, nona- and decasaccharides, preferably saccharides having 2 to 9 repeat units. The linkage within the chains takes place 1,4-glycosidically and optionally 1,6-glycosidically. The aldehyde sugars, even if they are oligomeric aldehyde sugars, have one reducing group per molecule.

Preferably, the aldehyde sugars (saccharides) used are compounds of the general formula I

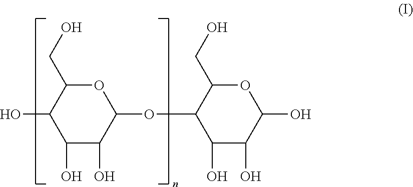

in which n is the number 0, 1, 2, 3, 4, 5, 6, 7 or 8.

The oligosaccharides in which n is an integer from 1 to 8 are particularly preferred. In this connection, it is possible to use oligosaccharides with a defined number of repeat units. Examples of oligosaccharides which may be mentioned are lactose, maltose, isomaltose, maltotriose, maltotetraose and maltopentaose.

Preferably, mixtures of oligosaccharides with a different number of repeat units are selected. Mixtures of this type are obtainable by hydrolysis of a polysaccharide, preferably of celluloase or starch, such as enzymatic or acidically catalyzed hydrolysis of cellulose or starch. Vegetable starch consists of amylose and amylopectin as main constituent of the starch. Amylose consists of predominantly unbranched chains of glucose molecules which are 1,4-glycosidically linked to one another. Amylopectin consists of branched chains in which, besides the 1,4-glycosidic linkages, there are additionally 1,6-glycosidic linkages which lead to branches. Also of suitability according to the invention are hydrolysis products of amylopectin as starting compound for the method according to the invention and are encompassed by the definition of oligosaccharides.

Primary aliphatic amines suitable for the reaction may be linear or branched. Within the context of this invention, primary aliphatic amines are aliphatic monoamines, preferably saturated monoamines, with one primary amino group. The saturated aliphatic radical is generally an alkyl radical, having preferably 1 to 8 carbon atoms, which can be interrupted by O atoms and which can optionally carry one or two carboxyl groups, hydroxyl groups and/or carboxamide groups.

Suitable primary aliphatic amines which are substituted with hydroxyl, carboxyl or carboxamide which may be mentioned are alkanolamines such as ethanolamine, and amino acids such as glycine, alanine, phenylalanine, serine, asparagine, glutamine, asparatic acid and glutamic acid. Suitable primary aliphatic amines, the alkylene radical of which is interrupted with oxygen, are preferably 3-methoxypropylamine, 2-ethoxy-ethylamine and 3-(2-ethylhexyloxy)propylamine.

As primary aliphatic amines, preference is given to using C₁-C₈-alkylamines, in particular C₁-C₄-alkylamines, such as ethylamine, 1-aminopropane, 2-aminopropane, 1-aminobutane, 2-aminobutane, in particular methylamine.

Preferably, the primary aliphatic amines are selected from methylamine and ethanolamine. Furthermore, the reaction with ammonia or mixtures of ammonia with primary aliphatic amines is preferred.

The anhydrides used are methacrylic anhydride and acrylic anhydride.

The preparation of the acrylamidoalkyl-polyhydroxy acid amides or methacrylamidoalkyl-polyhydroxy acid amides takes place schematically in two steps: in the first step of the reaction of the polyhydroxy acid lactone with the aliphatic diamine to give the corresponding aminoalkylaldonamide and in the second step of the reaction of the aminoalkylaldonamide with methacrylic anhydride or acrylic anhydride to give the unsaturated methacryl- or acrylamidoalkylpolyhydroxy acid amide according to the invention. Optionally, an interim isolation may be advantageous.

Hereinbelow, polyhydroxy acid lactone is to be understood as meaning lactones of saccharides from a natural and synthetic source oxidized merely on the anomeric carbon. Polyhydroxy acid lactones of this type can also be referred to as lactones of aldonic acids. The polyhydroxy acid lactones can be used individually or in their mixtures.

The saccharides are selectively oxidized only on the anomeric center. Processes for the selective oxidation are generally known and are described, for example, in J. Lönnegren, I. J. Goldstein, Methods Enzymology, 242 (1994) 116. For example, the oxidation can be carried out with iodine in an alkaline medium or with copper(II) salts. Suitable saccharides are the aforementioned saccharides, in particular the saccharides specified as being preferred.

Suitable aliphatic diamines can be linear, cyclic or branched. Within the context of this invention, aliphatic diamines are diamines having two primary or secondary amino groups, preferably having one primary and one further primary or secondary amino group, which are bonded with one another via an aliphatic, preferably saturated bivalent radical. The bivalent radical is generally an alkylene radical, having preferably 2 to 10 carbon atoms, which can be interrupted by O atoms and which can optionally carry one or two carboxyl groups, hydroxyl groups and/or carboxamide groups. Furthermore, aliphatic diamines are also understood as meaning cycloaliphatic diamines.

Examples of suitable aliphatic diamines which are substituted with hydroxyl, carboxyl or carboxamide which may be mentioned are N-(2-aminoethyl)ethanolamine, 2,4-diaminobutyric acid or lysine.

The suitable aliphatic diamines, the alkylene radical of which is interrupted with oxygen, are preferably α,ω-polyether diamines in which the two amino groups are at the chain ends of the polyether. Polyether diamines are preferably the polyethers of ethylene oxide, of propylene oxide and of tetrahydrofuran. The molecular weights of the polyether diamines are in the range from 200-3000 g/mol, preferably in the range from 230-2000 g/mol.

Preference is given to using aliphatic C₂-C₈-diamines and cycloaliphatic diamines, such as 1,2-diaminoethane, 1,3-diaminopropane, 1,5-diaminopentane, 1,6-diaminohexane, N-methyl-1,3-diaminopropane, N-methyl-1,2-diaminoethane, 2,2-dimethylpropane-1,3-diamine, diaminocyclohexane, isophoronediamine and 4,4′-diaminodicyclohexyl-methane.

Compounds with two or more ethylenically unsaturated radicals (monomers III) act as crosslinkers. Preference is given to using monomers with vinyl, allyl, acryl and/or methacryl groups.

Suitable monomers III with two ethylenically unsaturated radicals are, for example, divinylbenzene and divinylcyclohexane and preferably the diesters of diols with acrylic acid or methacrylic acid, also the diallyl and divinyl ethers of these diols. By way of example, mention may be made of ethanediol diacrylate, ethylene glycol dimethacrylate, 1,3-butylene glycol dimethacrylate, diethylene glycol diacrylate, dipropylene glycol diacrylate, methallylmethacrylamide, allyl acrylate and allyl methacrylate. Particular preference is given to propanediol diacrylate, butanediol diacrylate, pentanediol diacrylate and hexanediol diacrylate and the corresponding methacrylates.

Monomers III with three or more, generally 3, 4 or 5, ethylenically unsaturated radicals are, for example, the polyesters of polyols with acrylic acid and/or methacrylic acid, also the polyallyl and polyvinyl ethers of these polyols. Preference is given to monomers III with three or more ethylenically unsaturated radicals such as trimethyloipropane triacrylate and methacrylate, pentaerythritol triallyl ether, pentaerythritol tetraallyl ether, pentaerythritol triacrylate and pentaerythritol tetraacrylate, and their technical-grade mixtures. For example, as a rule, pentaerythritol tetraacrylate is present in technical-grade mixtures in a mixture with pentaerythritol triacrylate and small amounts of oligomerization products.

Suitable other monomers IV are monoethylenically unsaturated monomers which are different from the monomers I and II, such as styrene, β-methylstyrene, vinyl acetate, vinyl propionate and vinylpyridine.

The water-soluble monomers IV are particularly preferably acrylic acid, methacrylic acid, acrylonitrile, methacrylamide, itaconic acid, maleic acid, maleic anhydride, N-vinylpyrrolidone, and acrylamido-2-methylpropanesulfonic acid. In addition, mention is to be made in particular of N-methylolacrylamide, N-methylolmethacrylamide, dimethylaminoethyl methacrylate and diethylaminoethyl methacrylate.

Preference is given to using monomer compositions consisting of
25 to 90% by weight of one or more C₁-C₂₄-alkyl and/or glycidyl esters of acrylic acid and/or methacrylic acid,
5 to 75% by weight of one or more monomers selected from acrylic acid and/or methacrylic acid esters which carry hydroxy and/or carboxy groups, and allylgluconamide
15 to 40% by weight of one or more compounds having two or more ethylenically unsaturated radicals
0 to 10% by weight of one or more other monomers
   for the formation of the capsule wall polymer by free-radical polymerization.

Likewise preference is given to using monomer compositions comprising, preferably consisting of
25 to 95% by weight of one or more C₁-C₂₄-alkyl and/or glycidyl esters of acrylic acid and/or methacrylic acid,
30 to 75% by weight of one or more monomers selected from acrylic acid and/or methacrylic acid esters which carry hydroxy and/or carboxy groups, and allylgluconamide
0 to 40% by weight of one or more compounds having two or more ethylenically unsaturated radicals
0 to 5% by weight of one or more other monomers
   for the formation of the capsule wall polymer by free-radical polymerization.

The microcapsules according to the invention are obtainable by preparing a water-in-oil emulsion comprising hydrophobic diluent as continuous phase, and the hydrophilic capsule core material and the monomers and subsequent free-radical polymerization of the monomers to form the capsule wall polymer. The monomers can be used here in the form of a mixture. However, it is likewise possible to meter them in separately, depending on their hydrophilicity, i.e. solubility in water, in a mixture with the capsule core material and in a mixture with the hydrophobic diluent. Thus, the monomers II are preferably metered in in a mixture with the hydrophilic capsule core material. The monomers I are preferably metered in in a mixture with the hydrophobic diluent.

The continuous phase of the emulsion usually comprises surface-active substances in order to avoid coalescence of the droplets. In this emulsion, the water or the aqueous solution is the discontinuous later disperse phase and the hydrophobic diluent the continuous phase. The emulsified droplets here have a size which corresponds approximately to the size of the subsequent microcapsules. The wall formation takes place as a result of the polymerization of the monomer composition which is started by free-radical starters.

Hereinbelow, hydrophobic diluent is understood as meaning diluents which have a solubility in water of <1 g/l, preferably <0.5 g/l at 20° C. and standard pressure. Preferably, the hydrophobic diluent is selected from
cyclohexane,
glycerol ester oils,
hydrocarbon oils, such as paraffin oil, diisopropylnaphthalene, purcellin oil, perhydrosqualene and solutions of microcrystalline waxes in hydrocarbon oils,
animal or vegetable oils,
mineral oils, the distillation start-point of which under atmospheric pressure is ca. 250° C. and the distillation end-point of which is 410° C., such as e.g. Vaseline oil,
esters of saturated or unsaturated fatty acids, such as alkyl myristate, e.g. isopropyl myristate, butyl myristate or cetyl myristate, hexadecyl stearate, ethyl palmitate or isopropyl palmitate and cetyl ricinoleate,
silicone oils, such as dimethylpolysiloxane, methylphenylpolysiloxan and the silicone glycol copolymer,
fatty acids and fatty alcohols or waxes such as Carnauba wax, Candellila wax, beeswax, microcrystalline wax, ozokerite wax and Ca, Mg and Al oleates, myristates, linoleates and stearates.

Glycerol ester oils are understood as meaning esters of saturated or unsaturated fatty acids with glycerol. Mono-, di- and triglycerides, and their mixtures are suitable. Preference is given to fatty acid triglycerides. Fatty acids which may be mentioned are, for example, C₆-C₁₂-fatty acids such as hexanoic acid, octanoic acid, decanoic acid and dodecanoic acid. Preferred glycerol ester oils are C₆-C₁₂-fatty acid triglycerides, in particular octanoic acid and decanoic acid triglycerides, and their mixtures. Such an octanoyl glyceride/decanoyl glyceride mixture is for example Miglyol® 812 from Hüls.

In order to obtain a stable emulsion, surface-active substances such as protective colloids and/or emulsifiers are required. As a rule, surface-active substances are used which are miscible with the hydrophobic phase.

Preferred protective colloids are linear block copolymers with a hydrophobic structural unit of a length >50 Å, alone or in mixtures with other surface-active substances. The linear block copolymers are given by the general formula

C_{w}-(-B-A-B_{y}-)-xD_{z}

in which w is 0 or 1, x is 1 or more, y is 0 or 1 and z is 0 or 1 and A is a hydrophilic structural unit with a solubility in water at 25° C.>1% by weight (>10 g/l) and a molecular weight of from 200 to 50 000, which is covalently bonded to the B blocks, and B is a hydrophobic structural unit with a molecular weight of from 300 to 60 000 and a solubility <1% by weight in water at 25° C. and can form covalent bonds to A; and in which C and D are end groups which, independently of one another, can be A or B. The end groups can be identical or different and are dependent on the preparation process.

Examples of hydrophilic groups are polyethylene oxides, poly(1,3-dioxolane), copolymers of polyethylene oxide or poly(1,3-dioxolane), poly(2-methyl-2-oxazoline), poly(glycidyltrimethylammonium chloride) and polymethylene oxide.

Examples of hydrophobic groups are polyesters in which the hydrophobic moiety is a steric barrier ≧50 Å, preferably ≧75 Å, in particular ≧100 Å. The polyesters are derived from components such as 2-hydroxybutanoic acid, 3-hydroxybutanoic acid, 4-hydroxybutanoic acid, 2-hydroxycaproic acid, 10-hydrodecanoic acid, 12-hydroxydodecanoic acid, 16-hydroxyhexadecanoic acid, 2-hydroxyisobutanoic acid, 2-(4-hydroxyphenoxy)propionic acid, 4-hydroxyphenylpyruvic acid, 12-hydroxystearic acid, 2-hydroxyvaleric acid, polylactones of caprolactone and butyrolactone, polylactams of caprolactam, polyurethanes and polyisobutylenes. Preferably, the water-in-oil emulsion is stabilized with a 12-hydroxystearic acid block copolymer as linear block copolymer.

The linear block copolymers comprise both hydrophilic and hydrophobic units. The block copolymers have a molecular weight above 1000 and a length of the hydrophobic moiety of ≧50 Å calculated in accordance with the law of cosines. These parameters are calculated for a stretched-out configuration taking into consideration the binding lengths and angles given in the literature. The preparation of these units is generally known. Preparation processes are, for example, condensation reaction of hydroxy acids, condensations of polyols such as diols with polycarboxylic acids such as dicarboxylic acids. Also of suitability is the polymerization of lactones and lactams, and also the reaction of polyols with polyisocyanates. Hydrophobic polymer units are reacted with the hydrophilic units as generally known, for example by condensation reaction and coupling reaction. The preparation of such block copolymers is described for example in U.S. Pat. No. 4,203,877, to which reference is expressly made.

Preferably, the fraction of linear block copolymer is 20-100% by weight of the total amount of surface-active substance used.

Suitable surface-active substances are also the emulsifiers customarily used for water-in-oil emulsions, for example
C₁₂-C₁₈-sorbitan fatty acid esters,
esters of hydroxystearic acid and C₁₂-C₃₀ fatty alcohols,
mono- and diesters of C₁₂-C₁₈-fatty acids and glycerol or polyglycerol,
condensates of ethylene oxide and propylene glycols,
oxypropylenated/oxyethylenated C₁₂-C₂₀-fatty alcohols,
polycyclic alcohols, such as sterols,
aliphatic alcohols with a high molecular weight, such as lanolin,
mixtures of oxypropylenated/polyglycerolated alcohols and magnesium isostearate,
succinic esters of polyoxyethylated or polyoxypropylenated fatty alcohols,
magnesium, calcium, lithium, zinc or aluminum lanolate and stearate, optionally as a mixture with hydrogenated lanolin, lanolin alcohol, or stearic acid or stearyl alcohol.

Emulsifiers of the Span® series (ICI Americas, Inc.) have proven to be particularly advantageous. These are cyclized sorbitol sometimes polyesterified with a fatty acid, where the basic framework can also be substituted with further radicals known from surface-active compounds, for example with polyoxyethylene. By way of example, the sorbitan esters with lauric acid, palmitic acid, stearic acid and oleic acid may be mentioned, such as Span 80 (sorbitan monooleate) and Span 60 (sorbitan monostearate).

In a preferred embodiment oxypropylenated/oxyethylenated C₁₂-C₂₀-fatty alcohols are used as mixing component with further surface-active substances. These fatty alcohols generally have 3 to 12 ethylene oxide or propylene oxide units.

Preferably, C₁₂-C₁₈-sorbitan fatty acid esters are used as emulsifier. These can be used individually, in their mixtures and/or as mixtures with other aforementioned emulsifier types. Preferably, the fraction of sorbitan fatty acid esters is 20-100% by weight of the total amount of surface-active substance used.

In a preferred embodiment, a mixture of surface-active substances comprising the above-defined linear block copolymers and C₁₂-C₁₈-sorbitan fatty acid esters is selected.

Particularly preferably, a mixture of surface-active substances comprising the linear block copolymers C₁₂-C₁₈-sorbitan fatty acid esters and oxypropylenated/oxyethylenated C₁₂-C₂₀-fatty alcohols is selected.

Preference is given to those mixtures comprising 20 to 95% by weight, in particular 30 to 75% by weight, of linear block copolymer and 5 to 80% by weight, in particular 25 to 70% by weight, of C₁₂-C₁₈-sorbitan fatty acid esters, based on the total amount of surface-active substance. The fraction of oxypropylenated/oxyethylated C₁₂-C₂₀-fatty alcohol is preferably 0 to 20% by weight.

In particular, preference is given to mixtures of surface-active substances comprising essentially 40 to 60% by weight of linear block copolymer, 30 to 50% by weight of C₁₂-C₁₈-sorbitan fatty acid esters and 2 to 10% by weight of oxypropylenated/oxyethylenated C₁₂-C₂₀-fatty alcohols, based on the total amount of surface-active substance.

The optimum amount of surface-active substance is influenced firstly by the surface-active substance itself, secondly by the reaction temperature, the desired microcapsule size and the wall materials. The optimally required amount can be determined easily through simple experimental series. As a rule, the surface-active substance is used for preparing the emulsion in an amount of from 0.01 to 10% by weight, preferably 0.05 to 5% by weight and in particular 0.1 to 3% by weight, based on the hydrophobic phase.

Polymerization initiators which can be used are all compounds which disintegrate into free radicals under the polymerization conditions, e.g. peroxides, hydroperoxides, persulfates, azo compounds and the so-called redox initiators.

In some cases, it is advantageous to use mixtures of different polymerization initiators, e.g. mixtures of hydrogen peroxide and sodium or potassium peroxodisulfate. Mixtures of hydrogen peroxide and sodium peroxodisulfate can be used in any desired ratio. Suitable organic peroxides are, for example, acetylacetone peroxide, methyl ethyl ketone peroxide, tert-butyl hydroperoxide, cumene hydroperoxide, tert-amyl perpivalate, tert-butyl perpivalate, tert-butyl perneohexanoate, tert-butyl perisobutyrate, tert-butyl per-2-ethylhexanoate, tert-butyl perisononanoate, tert-butyl permaleate, tert-butyl perbenzoate, tert-butyl per-3,5,5-trimethylhexanoate and tert-amyl perneodecanoate. Further suitable polymerization initiators are azo starters, e.g. 2,2′-azobis-(2-amidinopropane) dihydrochloride, 2,2′-azobis(N,N-dimethylene)isobutyramidine dihydrochloride, 2-(carbamoylazo)isobutyronitrile and 4,4′-azobis(4-cyanovaleric acid).

Preference is given to using azo starters and peroxides as polymerization initiators. The specified polymerization initiators are used in customary amounts, e.g. in amounts of from 0.1 to 5, preferably 0.1 to 2.5 mol %, based on the monomers to be polymerized.

The dispersion of the core material takes place in a known manner according to the size of the capsules to be produced. For producing large capsules, dispersion using effective stirrers, in particular anchor stirrers and MIG (cross-arm) stirrers suffices. Small capsules, particularly if the size is to be below 50 μm, require homogenization and dispersion machines.

The capsule size can be controlled within certain limits via the rotational speed of the dispersing device/homogenizing device and/or with the help of the concentration of the surface-active substance and/or via its molecular weight, i.e. via the viscosity of the continuous phase. Here, as the rotational speed increases up to a limiting rotational speed, the size of the dispersed particles decreases.

In this connection, it is important that the dispersing devices are used at the start of capsule formation. In the case of continuously operating devices with forced flow, it is advantageous to send the emulsion several times through the shear field.

As a rule, the polymerization is carried out at 20 to 100° C., preferably at 40 to 95° C. The polymerization is expediently carried out at atmospheric pressure, although it is also possible to work at reduced or slightly increased pressure, e.g. in the case of a polymerization temperature above 100° C., thus for example in the range from 0.5 to 5 bar.

The reaction times of the polymerization are normally 1 to 10 hours, in most cases 2 to 5 hours.

By means of the method according to the invention it is possible to produce microcapsule dispersions with a content of from 5 to 40% by weight of microcapsules. The microcapsules are individual capsules. By means of suitable conditions during the dispersion, capsules with an average particle size in the range from 0.5 up to 100 μm can be produced. Preference is given to capsules with an average particle size of from 0.5 to 50 μm, in particular up to 20 μm.

The method according to the invention permits the production of microcapsules with a hydrophilic capsule core and a capsule wall made of a polymer based on (meth)acrylic acid esters. The capsules according to the invention can be used in a very wide variety of fields depending on the core material. In this way, it is possible to convert hydrophilic liquids or mixtures of organic acids or salts thereof, inorganic acids, inorganic bases, salts of inorganic acids, water-soluble dyes, flavorings, pharmaceutical active ingredients, fertilizers, crop protection active ingredients or cosmetic active ingredients into a solid formulation and/or oil-dispersible formulation which releases these as required.

Thus, microcapsules with a water core are suitable as pore formers for concrete. A further application in construction materials is the use of encapsulated water-soluble catalysts in binding construction materials.

Microcapsules with encapsulated inorganic or organic acids can advantageously be used as boring auxiliaries for, for example, geothermal bores since they permit a release only at the bore site. For example, they permit the increase in the permeability of underground, carbonatic mineral oil- and/or natural gas-carrying and/or hydrothermal rock formations for the dissolving of carbonatic and/or carbonate-containing impurities during the recovery of mineral oil and/or natural gas or the production of energy by hydrothermal geothermy by injecting a formulation comprising microcapsules according to the invention with encapsulated inorganic or organic acids through at least one bore into the rock formation. In addition, encapsulated acids, which afterall permit a delayed or targeted release of the acid, are also suitable as catalysts for producing chipboard.

Furthermore, the microcapsule dispersion according to the invention with water-soluble bleaches or enzymes as core material permits use in detergents and cleaners, especially in liquid formulations. Consequently, the present invention also provides the use of the microcapsules dispersion in detergents for textiles and cleaners for non-textile surfaces.

Furthermore, active ingredients which are to be released in a controlled manner, whether medical active ingredients, cosmetic active ingredients or else crop protection active ingredients, can be prepared such that release takes place over an extended period as a result of the tightness of the capsule wall.

### EXAMPLES

### Example 1

| | |
|---|---|
| Oil phase: | |
| 495.42 g | Miglyol ® 812(decanoyl/octanoyl glyceride fatty acid |
| | ester; Hüls) |
| 4.55 g | Arlacel ® P 135 (PEG-30 dipolyhydroxystearate, |
| | Atlas Chemie) |
| 1.19 g | Cremophor A 6 [75% by weight ceteareth-6 (ethoxylated |
| | cetyl alcohol)] |
| 1.19 g | Span ® 80 (sorbitan monooleate) |
| 4.55 g | Span 85 (sorbitan trioleate) |
| 12.00 g | methyl methacrylate |
| 8.00 g | 1,4-butanediol diacrylate |
| Feed 1 | |
| 160.00 g | water (core material) |
| 20.00 g | N-maltoyl-N-methylmethacrylamide |
| Feed 2 | |
| 1.33 g | of a 75% strength by weight aqueous solution of tert-butyl |
| | perpivalate |

The oil phase was introduced as initial charge, feed 1 was added and the mixture was dispersed for 30 minutes using a high-speed dissolver stirrer (disk diameter 5 cm) at 5000 rpm. Feed 2 was then added. The emulsion was heated to 60° C. with stirring using an anchor stirrer in 60 minutes. Over 120 minutes, the temperature was increased to 70° C. and heated to 85° C. over a further 30 minutes. The mixture was then stirred for 120 minutes at this temperature. It was then cooled to room temperature. An oil-based microcapsule dispersion with an average particle size D [4,3] of <1 μm was obtained. The wall thickness of the microcapsules was 20% by weight and the solids content of the microcapsule dispersion was 30% by weight.

### Example 2

| | |
|---|---|
| Oil phase: | |
| 495.42 g | diisopropylnaphthalene |
| 4.55 g | Arlacel P 135 |
| 1.19 g | Cremophor A 6 |
| 1.19 g | Span 80 |
| 4.55 g | Span 85 |
| 12.00 g | methyl methacrylate (MMA) |
| 8.00 g | 1,4-butanediol diacrylate (BDDA) |
| Feed 1: | |
| 100.00 g | water (core material) |
| 60.00 g | maleic acid |
| 20.00 g | N-allylgluconamide |
| Feed 2: | |
| 1.33 g | of a 75% strength by weight aqueous solution of |
| | tert-butyl perpivalate |

The oil phase was introduced as initial charge, feed 1 was added and the mixture was dispersed for 30 minutes using a high-speed dissolver stirrer (disk diameter 5 cm) at 5000 rpm. Feed 2 was added. The emulsion was heated to 60° C. with stirring using an anchor stirrer over the course of 60 minutes. Over 120 minutes, the temperature was increased to 70° C. and heated to 85° C. over a further 30 minutes. The mixture was then stirred for 120 minutes at this temperature. It was then cooled to room temperature. An oil-based microcapsule dispersion with an average particle size D [4,3] of <1 μm was obtained. The wall thickness of the microcapsules was 20% by weight. The solids content of the microcapsule dispersion was 30% by weight.

### Example 3

| | |
|---|---|
| Oil phase: | |
| 608.77 g | diisopropylnaphthalene |
| 10.00 g | Atlox ® 4912 |
| 12.50 g | methyl methacrylate (MMA) |
| Feed 1: | |
| 225.00 g | water |
| 7.73 g | of a 97% strength aqueous solution of 2-hydroxyethyl |
| | methacrylate (HEMA) |
| 1.00 g | sodium peroxodisulfate |
| 5.00 g | of a C₁₆/₁₈ fatty alcohol polyglycol ether (Lutensol AT 25) |

The oil phase was introduced as initial charge at 40° C., feed 1 was added and the mixture was stirred for 30 minutes using a high-speed dissolver stirrer (disk diameter 5 cm) at 3000 rpm. Feed 2 was added. The emulsion was heated to 60° C. with stirring using an anchor stirrer over the course of 60 minutes. Over 120 minutes, the temperature was increased to 70° C. and heated to 85° C. over the course of a further 30 minutes. The mixture was then stirred for 120 minutes at this temperature. It was then cooled to room temperature.

An oil-based microcapsules dispersion with an average particle size D [4,3] of <1 μm was obtained. The wall thickness of the microcapsules was 7.75% by weight and the solids content of the microcapsules dispersion was 30% by weight.

### Example 4

| | |
|---|---|
| Oil phase: | |
| 608.69 g | diisopropylnaphthalene |
| 5.00 g | Atlox 4912 |
| 15.00 g | methyl methacrylate (MMA) |
| Feed 1: | |
| 225.00 g | water |
| 10.31 g | of a 97% strength by weight aqueous solution of 2-hydroxyethyl |
| | methacrylate (HEMA) |
| 1.00 g | sodium peroxodisulfate |

The oil phase was introduced as initial charge, feed 1 was added and the mixture was dispersed for 20 minutes using a high-speed dissolver stirrer (disk diameter 5 cm) at 3000 rpm. The emulsion was heated to 60° C. with stirring using an anchor stirrer over the course of 60 minutes. Over 120 minutes, the temperature was increased to 70° C. and heated to 85° C. over a further 30 minutes. The mixture was then stirred for 120 minutes at this temperature. It was then cooled to room temperature.

An oil-based microcapsule dispersion with an average particle size D [4,3] of <1 μm was obtained. The wall thickness of the microcapsules was 10% by weight, based on wall and core. The solids content of the microcapsules dispersion was 30% by weight.

### Example 5

| | |
|---|---|
| Oil phase: | |
| 453.68 g | diisopropylnaphthalene |
| 1.50 g | Atlox 4912 |
| 18.00 g | methyl methacrylate (MMA) |
| Feed 1: | |
| 270.00 g | water |
| 12.37 g | of a 97% strength by weight aqueous solution of 2-hydroxyethyl |
| | methacrylate (HEMA) |
| 1.20 g | sodium peroxodisulfate |

The oil phase was introduced as initial charge, feed 1 was added and the mixture was dispersed for 10 minutes using a high-speed dissolver stirrer (disk diameter 5 cm) at 2000 rpm. The emulsion was heated to 60° C. with stirring using an anchor stirrer in 60 minutes. Over 120 minutes, the temperature was increased to 70° C. and heated to 85° C. over a further 30 minutes. The mixture was then stirred for 120 minutes at this temperature. It was then cooled to room temperature. The wall thickness of the microcapsules was 10% by weight of the microcapsules. The solids content of the microcapsule dispersion was 40% by weight.

### Example 6

| | |
|---|---|
| Oil phase: | |
| 800.00 g | diisopropylnaphthalene |
| 8.00 g | Atlox 4912 |
| Feed 1: | |
| 205.70 g | of a 35% strength sodium silicate solution in water |
| 154.30 g | water |
| Feed 2: | |
| 34.00 g | methyl methacrylate (MMA) |
| 4.00 g | 1,4-butanediol diacrylate |
| 2.00 g | 2-hydroxyethyl methacrylate |
| Feed 3: | |
| 0.15 g | Wako V 50 [2,2′-azobis(2-amidinopropane) dihydrochloride] |
| Feed 4: | |
| 0.15 g | Wako V 65 [2,2′-azobis(2,4-dimethylvaleronitrile)] |

The oil phase was introduced as initial charge, feed 3 was dissolved in feed 1, and feeds 1 and 2 were added to the oil phase. The mixture was dispersed for 20 minutes using a high-speed dissolver stirrer (disk diameter 5 cm) at 2000 rpm and then feed 4 was added. The emulsion was heated to 67° C. with stirring using an anchor stirrer over the course of 60 minutes and to 75° C. over a further 60 minutes. The mixture was then stirred for 180 minutes at this temperature. It was then cooled to room temperature. The wall thickness of the microcapsules was 10% by weight of the microcapsules. The solids content of the microcapsule dispersion was 34% by weight.

### Example 7

Analogously to example 2, in place of the mixture of maleic acid and water, instead a mixture of 70.59 g of phosphoric acid and 89.41 g of water was encapsulated.

The wall thickness of the microcapsules was 20% by weight of the microcapsules. The solids content of the microcapsule dispersion was 30% by weight.

### Example 8

Analogously to example 2, in place of the mixture of maleic acid and water, instead 60.00 g of catechol were encapsulated with 100.00 g of water.

The wall thickness of the microcapsules was 20% by weight of the microcapsules. The solids content of the microcapsule dispersion was 30% by weight.

### Example 9

Analogously to example 3, a microcapsule dispersion was prepared, where the oil phase used was a mixture of

| | |
|---|---|
| 597.10 g | diisopropylnaphthalene |
| 5.00 g | Atlox ® 4912 |
| 12.50 g | methyl methacrylate (MMA). |

The wall thickness of the microcapsules was 7.75% by weight of the microcapsules. The solids content of the microcapsule dispersion was 30% by weight.

### Example 10

Analogously to example 4, a microcapsule dispersion was prepared, a mixture of

| | |
|---|---|
| 225.00 g | water |
| 10.00 g | 2-hydroxyethyl acrylate |
| 1.00 g | sodium peroxodisulfate |

being used as feed 1.

The wall thickness of the microcapsules was 10% by weight of the microcapsules. The solids content of the microcapsule dispersion was 29.6% by weight.

### Example 11

Analogously to example 4, a microcapsule dispersion was prepared, where the oil phase had the following composition.

Oil phase:

| | |
|---|---|
| 588.27 g | diisopropylnaphthalene |
| 1.25 g | Atlox 4912 |
| 10.00 g | methyl methacrylate (MMA) |
| 5.00 g | 1,4-butanediol diacrylate |

The wall thickness of the microcapsules was 10% by weight of the microcapsules. The solids content of the microcapsule dispersion was 30% by weight.

### Example 12

| | |
|---|---|
| Oil phase: | |
| 495.42 g | diisopropylnaphthalene |
| 4.55 g | Arlacel P 135 |
| 1.19 g | Cremophor A 6 |
| 1.19 g | Span 80 |
| 4.55 g | Span 85 |
| 12.00 g | methyl methacrylate (MMA) |
| 8.00 g | 1,4-butanediol diacrylate (BDDA) |
| Feed 1: | |
| 89.41 g | water (core material) |
| 70.59 g | phosphoric acid |
| 20.00 g | 1-methacrylamido-2-D-gluconoylaminoethane |
| Feed 2: | |
| 1.33 g | of a 75% strength by weight aqueous solution of |
| | tert-butyl perpivalate |

The oil phase was introduced as initial charge, feed 1 was added and the mixture was dispersed for 30 minutes using a high-speed dissolver stirrer (disk diameter 5 cm) at 5000 rpm. Feed 2 was added. The emulsion was heated to 60° C. with stirring using an anchor stirrer over the course of 60 minutes. Over 120 minutes, the temperature was increased to 70° C. and heated to 85° C. over a further 30 minutes. The mixture was then stirred for 120 minutes at this temperature. It was then cooled to room temperature.

An oil-based microcapsule dispersion with an average particle size D [4,3] of <1 μm was obtained. The wall thickness of the microcapsules was 20% by weight. The solids content of the microcapsule dispersion was 30% by weight.

### Example 13

Analogously to example 4, but with 1.00 g of Wako V50 instead of sodium peroxodisulfate and with the oil phase described in example 11, a microcapsule dispersion was prepared.

The wall thickness of the microcapsules was 10% by weight of the microcapsules. The solids content of the microcapsule dispersion was 30% by weight.

### Example 14

| | |
|---|---|
| Oil phase: | |
| 588.27 g | diisopropylnaphthalene |
| 1.25 g | Atlox 4912 |
| 7.50 g | methyl methacrylate (MMA) |
| 10.00 g | tert-butyl acrylate |
| Feed 1: | |
| 225.00 g | water |
| 7.73 g | of a 97% strength by weight aqueous solution of |
| | 2-hydroxyethyl methacrylate (HEMA) |
| 1.00 g | Wako V 50 |

The oil phase was introduced as initial charge, feed 1 was added and the mixture was dispersed for 10 minutes using a high-speed dissolver stirrer (disk diameter 5 cm) at 2000 rpm. The emulsion was heated to 60° C. with stirring using an anchor stirrer over the course of 60 minutes. Over 120 minutes, the temperature was increased to 70° C. and heated to 85° C. over a further 30 minutes. The mixture was then stirred for 120 minutes at this temperature. It was then cooled to room temperature.

An oil-based microcapsule dispersion with an average particle size D [4,3] of <1 μm was obtained. The wall thickness of the microcapsules was 10% by weight, based on wall and core. The solids content of the microcapsule dispersion was 30% by weight.

### Example 15

Analogously to example 14, in place of 10.00 g of tert-butyl acrylate, 10.00 g of glycidyl methacrylate were used.

The wall thickness of the microcapsules was 10% by weight and the solids content of the microcapsule dispersion was 30% by weight.

U.S. Provisional Patent Application No. 61/577,105, filed on Dec. 19, 2011, is included in the present application by literature reference.

1. A microcapsule dispersion comprising microcapsules comprising a hydrophilic capsule core and a capsule wall polymer which is obtainable by polymerization of a monomer composition comprising
25 to 95% by weight of one or more C₁-C₂₄-alkyl and/or glycidyl esters of acrylic acid and/or methacrylic acid
5 to 75% by weight of one or more hydrophilic monomers selected from acrylic acid esters and/or methacrylic acid esters which carry hydroxy and/or carboxy groups, and allyigluconamide
0 to 40% by weight of one or more compounds having two or more ethylenically unsaturated radicals,
where the microcapsules are dispersed in a hydrophobic diluent.

2. The microcapsule dispersion according to claim 1, wherein the hydrophilic capsule core of the microcapsules is selected from water, and aqueous solutions of organic acids, and salts thereof, inorganic acids and inorganic salts and of sodium silicate.

3. The microcapsule dispersion according to claim 1 or 2, wherein the monomer composition comprises methyl methacrylate.

4. The microcapsule dispersion according to any one of claims 1 to 3, wherein the hydrophilic monomer is selected from hydroxyalkyl acrylates, hydroxyalkyl methacrylates, acrylamidoalkyl-polyhydroxy acid amides, methacrylamidoalkyl-polyhydroxy acid amides, N-acryl-glycosylamines and N-methacryl-glycosylamines.

5. The microcapsule dispersion according to any one of claims 1 to 4, obtainable by preparing a water-in-oil emulsion comprising hydrophobic diluent as continuous phase, and the hydrophilic capsule core material and the monomer composition and subsequent free-radical polymerization of the monomers to form the capsule wall polymer.

6. The microcapsule dispersion according to any one of claims 1 to 5, wherein the hydrophobic diluent has a solubility in water <0.5 g/l at 20° C. and atmospheric pressure.

7. A method for producing a microcapsule dispersion according to any one of claims 1 to 6, wherein a water-in-oil emulsion comprising a hydrophobic diluent as continuous phase, and the hydrophilic capsule core material and the monomer composition is prepared and then the monomers are free-radically polymerized, the monomer composition comprising
25 to 95% by weight of one or more C₁-C₂₄-alkyl and/or glycidyl esters of acrylic acid and/or methacrylic acid
5 to 75% by weight of one or more hydrophilic monomers selected from acrylic acid esters and/or methacrylic acid esters which carry hydroxy and/or carboxy groups, and allylgiuconamide
0 to 40% by weight of one or more compounds having two or more ethylenically unsaturated radicals.

8. The method according to claim 7, wherein the water-in-oil emulsion is stabilized with a surface-active substance which is a linear block copolymer with a hydrophobic structural unit of a length of more than 50 Å and which is defined by the general formula
C_{w}-(-B-A-B_{y}-)-xD_{z}
in which
w is 0 or 1,
x is 1 or more,
y is 0 or 1, and
z is 0 or 1
A is a hydrophilic structural unit which has a molar mass of from 200 to 50 000 with a solubility in water at 25° C.>1% by weight, and is selected such that it is covalently bonded to B, and
B is a hydrophobic structural unit which has a molar mass of from 300 to 60 000 and a solubility in water at 25° C. of <1% and can be covalently bonded to A, and
C and D are end groups which, independently of one another, can be A or B.

9. The method according to claim 8, wherein the water-in-oil emulsion is stabilized with a 12-hydroxystearic acid block copolymer as linear block copolymer.

10. The method according to claim 8, wherein the water-in-oil emulsion is stabilized with C₁₂-C₁₈-sorbitan fatty acid ester as surface-active substance.

11. A microcapsule comprising a hydrophilic capsule core and a capsule wall polymer which is obtainable by polymerization of a monomer composition comprising
25 to 95% by weight of one or more C₁-C₂₄-alkyl and/or glycidyl esters of acrylic acid and/or methacrylic acid
5 to 75% by weight of one or more hydrophilic monomers selected from acrylic acid esters and/or methacrylic acid esters which carry hydroxy and/or carboxy groups, and allylgiuconamide
0 to 40% by weight of one or more compounds having two or more ethylenically unsaturated radicals.

12. The use of the microcapsule dispersion according to claims 1 to 6 comprising water or inorganic acids as auxiliary for modifying binding construction materials.

13. The use of the microcapsule dispersion according to claims 1 to 6 with a cosmetic active ingredient as core material as a constituent in cosmetic preparations.

14. The use of the microcapsule dispersion according to claims 1 to 6 with crop protection active ingredients as core materials as a constituent in agrochemical formulations.
